(19) United States
(12) Patent Application Publication
(10) Pub. No.: US 2025/0129653 A1
(43) Pub. Date: Apr. 24, 2025

(54) SPINDLE DRIVE

(71) Applicant: Brose Fahrzeugteile SE & Co. Kommanditgesellschaft, Bamberg, Bamberg (DE)

(72) Inventors: Michael Schneiderbanger, Rattelsdorf (DE); Tobias Zwosta, Wilhelmsthal (DE); Daniela Schweizer, Coburg (DE); Dieter Franz, Breitenguessbach (DE); Manfred Barthelmess, Scheinfeld (DE)

(21) Appl. No.: 18/685,530

(22) PCT Filed: Aug. 22, 2022
(86) PCT No.: PCT/EP2022/073274

§ 371 Date: Feb. 22, 2024

(30) Foreign Application Priority Data
Aug. 23, 2021 (DE) 10 2021 121 801.2

(51) Int. Cl. E05F 15/622; B60J 5/10

(52) U.S. Cl. CPC E05F 15/622; B60J 5/106; E05Y 2900/546

(57) ABSTRACT

A spindle drive for a closure element of a vehicle is provided, wherein the spindle drive has a spindle/spindle nut mechanism, which has a spindle and a spindle nut meshing therewith for generating linear drive movements along a geometric spindle axis between a spindle-side drive connection and a spindle nut-side drive connection for channeling the drive movements, wherein the spindle is axially movably guided in a spindle guide tube which is axially fixedly connected to the spindle nut for conjoint rotation and which is axially fixedly coupled to the spindle nut-side drive connection. It is proposed that the spindle nut is axially inserted over its entire length into a portion of the spindle guide tube that is formed in such a way as to be in form-fitting engagement with the spindle nut in both directions along the geometric spindle axis and in the circumferential direction around the geometric spindle axis.

### CROSS-REFERENCE TO RELATED APPLICATIONS

This application is a national stage application under 35 U.S.C. 371 of International Patent Application Serial No. PCT/EP2022/073274, entitled “Spindle Drive,” filed on Aug. 22, 2022, which claims priority from German Patent Application No. DE 102021121801.2, filed Aug. 23, 2021, the disclosure of which is incorporated herein by reference.

### FIELD OF THE TECHNOLOGY

A spindle drive for a closure element, to a closure element assembly, and to a method.

### BACKGROUND

The known spindle drive (DE 10 2013 003 830 A1) from which some embodiments proceed serves for the motorized adjustment of a tailgate of a motor vehicle. The spindle drive has an electric drive unit and a spindle/spindle nut gear mechanism which is disposed downstream of the electric drive unit and by way of which rotating movements are converted into linear drive movements for opening and closing the closure element between a spindle-proximal drive connection and a spindle nut-proximal drive connection. The spindle nut is composed of plastics material, and is insert-molded into the spindle guide tube in an injection-molding process. The spindle guide tube has at least one opening in the circumferential direction, part of the spindle nut protruding radially through said at least one opening, as a result of which the spindle nut is disposed so as to co-rotate with the spindle guide tube.

The known spindle drive reliably establishes a co-rotational connection between the spindle nut and the spindle guide tube. However, owing to the fact that the spindle nut is insert-molded into the spindle guide tube, a challenge lies in that the production is complex and time-consuming. The spindle guide tube has to be placed into the injection-molding tool in a precise orientation. In order to be able to guarantee positive flow properties of the plastic melt along the metallic spindle guide tube, the spindle guide tube may potentially have to be pre-heated prior to the injection-molding process so as to achieve a positive connection between the spindle guide tube and the plastics material of the spindle nut, the production thus being associated with additional complexity.

### SUMMARY

Various embodiments are based on the object of designing and refining the known spindle drive in such a manner that rapid and simple production is made possible.

The above object is achieved by various embodiments provided herein.

The term “closure element” herein is to be understood in a wide sense. It comprises, for example, a tailgate, a trunk lid, a hood, a side door, a cargo space hatch, a window glass, a lifting roof, or the like, of a motor vehicle. The field of application of adjusting a tailgate of a motor vehicle is the focus hereunder.

The fundamental concept to design the spindle nut so as to be insertable into the spindle guide tube and to provide the spindle guide tube with a shape by way of which the spindle nut in the assembled state is held in a form-fitting manner in both axial directions along the geometric spindle axis and in the circumferential direction is essential. The spindle guide tube, even prior to the insertion of the spindle nut, can be designed in such a way that a co-rotational engagement between the spindle nut and the spindle guide tube is generated as a result of the insertion. In this instance, it is not necessary for the spindle nut to be injected into the spindle guide tube. The production of the spindle nut and of the spindle guide tube can be performed in a mutually independent manner. At the same time, the spindle nut can easily be brought to engage with the spindle guide tube in an axially and circumferentially form-fitting manner.

In detail, it is very generally proposed that the spindle nut over its entire length is inserted axially into a portion of the spindle guide tube that is shaped in such a manner that said portion engages with the spindle nut in a form-fitting manner in both directions along the geometric spindle axis and in the circumferential direction about the geometric spindle axis.

According to various embodiments, the spindle nut has at least one radially outward-projecting wing which engages in a corresponding internally configured depression in the spindle guide tube, as a result of which a form-fitting engagement in the circumferential direction is established between the spindle nut and the spindle guide tube.

According to various embodiments, the spindle guide tube is guided in an axially movable and co-rotational manner in a torsion tube which is coupled in an axially fixed and co-rotational manner to the spindle-proximal drive connection, as a result of which a simple structural solution for supporting the torque of the spindle nut is achieved. In order to achieve this torque support, the spindle guide tube can have a radially outward-directed convexity which engages with a corresponding guide groove in the torsion tube in a form-fitting manner in the circumferential direction.

Various embodiments relate to shapings of the spindle guide tube that are easy to produce. In this way, each internal depression and/or outward-projecting convexity can be formed by a corrugation. A cylindrical tube has only to be partially widened in order for the corrugation to be produced. As a result, a depression is created internally, while a corresponding congruent convexity is created externally.

Various embodiments relate to shapings of the spindle nut that are easy to produce.

According to various embodiments, the spindle nut at its axial ends is held in the axial direction in the spindle guide tube in each case by an internal protrusion of the spindle guide tube. The protrusions enable the spindle nut to be axially secured in the spindle guide tube in a simple and cost-effective manner. Various embodiments relate to shapings of the respective protrusion.

An annular intermediate piece by way of which a clamping force is advantageously exerted on the spindle nut by the spindle guide tube can be provided in the axial direction between the spindle nut and the respective internal protrusion.

According to various embodiments, the spindle is composed of metal. Alternatively or additionally, the spindle nut and/or the spindle guide tube can be composed of a plastics material and/or a metal. The choice of the materials can in this instance take place so as to correspond to the specific application of the spindle drive, as a result of which different coefficients of friction between the spindle nut and the spindle can in particular also be adjusted.

According to various embodiments, the spindle drive is able to be driven by a motor or without a motor. In this way, the spindle drive in a tailgate or the like is suitable as a closure element for use as the active side as well as for use as the passive side.

According to various embodiments, the spindle drive is designed to be restorable or self-locking. In this way, the spindle drive is suitable for specific applications in which manual restoring, or a self-locking embodiment, is required.

According to various embodiments, a closure element assembly of a motor vehicle having a closure element and a spindle drive according to the proposal is provided. In this context, reference may be made to all statements pertaining to the spindle drive according to the proposal.

According to various embodiments, a method for producing a spindle drive for a closure element of a motor vehicle, in particular a spindle drive according to the proposal, is provided, wherein the spindle drive in the assembled state has a spindle/spindle nut gear mechanism which has a spindle and a mating meshing spindle nut for generating linear drive movements along a geometric spindle axis between a spindle-proximal drive connection and a spindle nut-proximal drive connection for the output of the drive movements, wherein the spindle in the assembled state is guided so as to be movable axially in a spindle guide tube which is connected to the spindle nut in an axially fixed and co-rotational manner, and is coupled to the spindle nut-proximal drive connection in an axially fixed manner. In this context, reference may be made to all statements pertaining to the spindle drive according to the proposal.

In various embodiments, a fundamental concept of forming a spindle guide tube from a provided spindle guide tube blank by incorporating at least one inward-directed depression and one inward-directed protrusion into the spindle guide tube blank is essential. It is furthermore essential that a spindle nut provided with at least one outward-projecting wing is inserted into the formed spindle guide tube, and that the spindle guide tube is subsequently formed in such a way that the spindle nut is secured axially between the protrusion and the reshaping on the spindle guide tube. As a result of these method steps, the production can be simplified in comparison to injecting the spindle nut into the spindle guide tube, as a result of which savings in terms of time and costs are achieved.

In detail, it is very generally proposed that a spindle guide tube blank is provided, that the spindle guide tube is formed by incorporating at least one internal depression and at least one internal protrusion into the spindle guide tube blank, that subsequently a spindle nut having at least one radially outward-projecting wing is inserted axially into the spindle guide tube in such a way that one radially outward-projecting wing of the spindle nut comes to engage in each case with one assigned inward-directed depression of the spindle guide tube in a form-fitting manner in the circumferential direction about the geometric spindle axis, and that subsequently the spindle guide tube is formed by reshaping, in particular beading, and the spindle nut is secured axially between the protrusion and the reshaping on the spindle guide tube.

Various embodiments provide a spindle drive for a closure element of a motor vehicle, wherein the spindle drive has a spindle/spindle nut gear mechanism which has a spindle and a mating meshing spindle nut for generating linear drive movements along a geometric spindle axis between a spindle-proximal drive connection and a spindle nut-proximal drive connection for the output of the drive movements, wherein the spindle is guided so as to be movable axially in a spindle guide tube which is connected to the spindle nut in an axially fixed manner and co-rotational manner, and is coupled to the spindle nut-proximal drive connection in an axially fixed manner, wherein the spindle nut over its entire length is inserted axially into a portion of the spindle guide tube that is shaped in such a manner that said portion engages with the spindle nut in a form-fitting manner in both directions along the geometric spindle axis and in the circumferential direction about the geometric spindle axis.

In various embodiments, the spindle nut has at least one radially outward-projecting wing, such as at least two radially outward-projecting wings or exactly two radially outward-projecting wings which engages/engage in each case in a corresponding internal depression in the spindle guide tube in a form-fitting manner in the circumferential direction about the geometric spindle axis.

In various embodiments, the spindle guide tube, and by way of the latter the spindle nut, is guided in an axially movable and co-rotational manner in a torsion tube, and in that the torsion tube is coupled to the spindle-proximal drive connection in an axially fixed and co-rotational manner. In some embodiments, the spindle guide tube has at least one radially outward-projecting convexity, such as at least two radially outward-projecting convexities or exactly two radially outward-projecting convexities which engages/engage in each case in a corresponding internal guide groove in the torsion tube in a form-fitting manner in the circumferential direction about the geometric spindle axis.

In various embodiments, provided for each internal depression is one outward-projecting convexity. In various embodiments, one internal depression and one outward-projecting convexity are in each case congruent in radial terms.

In various embodiments, the respective internal depression and/or outward-projecting convexity is formed by a corrugation. In some embodiments, the corrugation runs parallel to the geometric spindle axis.

In various embodiments, the spindle nut is free from externally encircling depressions, and/or has a cylindrical surface contour in the circumferential portion or circumferential portions that is/are free from outward-projecting wings.

In various embodiments, the spindle nut at its axial ends engages in each case in at least one internal protrusion, in particular an internally encircling protrusion, in the spindle guide tube in a respective form-fitting manner in one of the two directions along the geometric spindle axis.

In various embodiments, the internal protrusion, by way of which the spindle nut at its axial end facing the spindle nut-proximal drive connection engages in a form-fitting manner in a first direction along the geometric spindle axis, is formed by reshaping the spindle guide tube, in particular knurling or crimping.

In various embodiments, the internal protrusion, by way of which the spindle nut at its axial end facing the spindle-proximal drive connection engages in a form-fitting manner in a second direction along the geometric spindle axis, is formed by reshaping, in particular beading, the axial end of the spindle guide tube facing the spindle-proximal drive connection.

In various embodiments, disposed axially between the spindle nut and the internal protrusion, in particular the internal protrusion formed by reshaping, in particular beading, the axial end of the spindle guide tube, is an annular intermediate piece which transmits an axial clamping force from the spindle guide tube, in particular the internal protrusion, to the spindle nut. In some embodiments, the intermediate piece is a metal disk.

In various embodiments, the spindle is made of metal, and/or in that the spindle nut and/or the spindle guide tube are/is made of a plastics material, in particular of a thermoplastic material, and/or of metal.

In various embodiments, provided is a drive unit having an electric motor which drives the spindle in a rotating manner, or in that the spindle drive is without a motor.

In various embodiments, the spindle drive is designed to be restorable or self-locking.

Various embodiments provide a closure element assembly of a motor vehicle, having a closure element and a spindle drive as described herein.

Various embodiments provide a method for producing a spindle drive for a closure element of a motor vehicle, in particular a spindle drive as described herein, wherein the spindle drive in the assembled state has a spindle/spindle nut gear mechanism which has a spindle and a mating meshing spindle nut for generating linear drive movements along a geometric spindle axis between a spindle-proximal drive connection and a spindle nut-proximal drive connection for the output of the drive movements, wherein the spindle in the assembled state is guided so as to be movable axially in a spindle guide tube which is connected to the spindle nut in an axially fixed and co-rotational manner, and is coupled to the spindle nut-proximal drive connection in an axially fixed manner, wherein a spindle guide tube blank is provided, the spindle guide tube is formed by incorporating at least one internal depression and at least one internal protrusion into the spindle guide tube blank, subsequently a spindle nut having at least one radially outward-projecting wing is inserted axially into the spindle guide tube in such a way that one radially outward-projecting wing of the spindle nut comes to engage in each case with one assigned inward-directed depression of the spindle guide tube in a form-fitting manner in the circumferential direction about the geometric spindle axis, and subsequently the spindle guide tube is formed by reshaping, in particular beading, and the spindle nut is secured axially between the protrusion and the reshaping on the spindle guide tube.

### BRIEF DESCRIPTION OF THE DRAWINGS

Various aspects will be explained in more detail hereunder by means of a drawing which only illustrates exemplary embodiments. In the drawing:

FIG. 1 shows the rear region of a motor vehicle having a spindle drive according to the proposal for the closure element assembly thereon;

FIG. 2 shows the spindle drive according to FIG. 1 in a) a retracted position, and b) a deployed position; and

FIG. 3 shows the spindle/spindle nut gear mechanism of the spindle drive from FIG. 1 in a) an exploded view, and b) a longitudinal sectional view.

### DETAILED DESCRIPTION

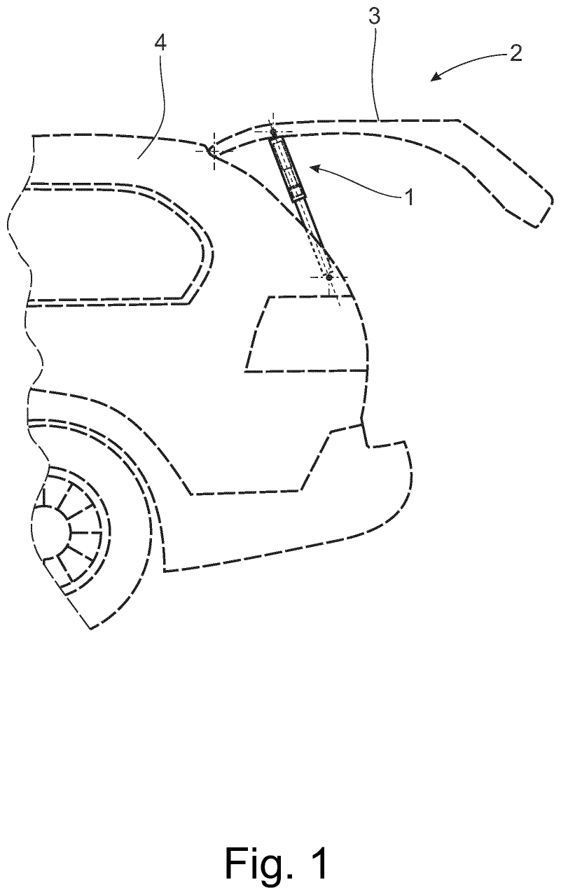

The spindle drive 1 according to the proposal is assigned to a closure element assembly 2, in FIG. 1 to a tailgate assembly, for example, which in turn is equipped with a closure element 3, here a tailgate. The closure element assembly 2 is assigned to a motor vehicle 4.

As mentioned at the outset, the closure element 3 may also be a different closure element 3 of a motor vehicle 4, in particular a trunk lid, or else a sliding door. All statements apply in an analogous manner to other closure elements 3.

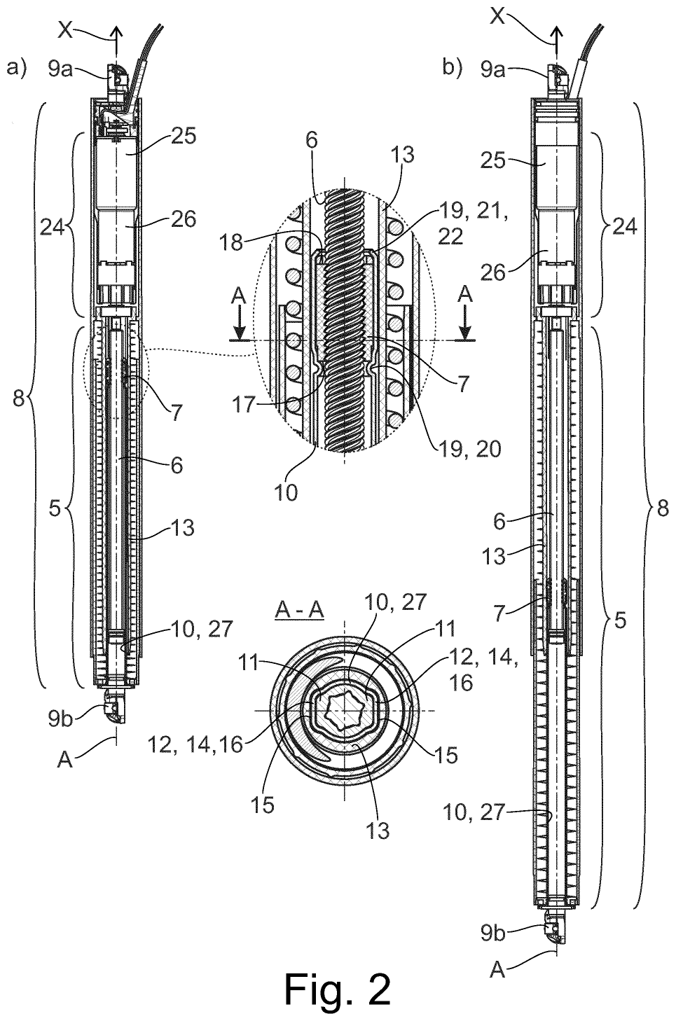

FIG. 2 shows that, for opening and closing the closure element 3, the spindle drive 1 has a spindle/spindle nut gear mechanism 5 having a geometric spindle axis A running in an axial direction X for generating linear drive movements in a first adjustment direction, the latter corresponding in particular to opening the closure element 3, and in a second adjustment direction, the latter corresponding in particular to closing the closure element 3. The geometric spindle axis A relates to the spindle drive 1.

In general, it is advantageous for the first adjustment direction to correspond to opening the closure element 3 if the closure element 3 is a tailgate or a trunk lid, because opening in this instance is already performed counter to the force of the weight of the closure element 3. Nevertheless, embodiments in which the opening is to be decelerated are conceivable. It can be provided in particular in the case of sliding doors that the first adjustment direction corresponds to closing the corresponding closure element 3. The spindle drive 1 can readily be disposed so as to be displaceable on the closure element 3 or the motor vehicle 4.

The spindle/spindle nut gear mechanism 5 of the spindle drive 1, in a customary manner, is equipped with a rotating spindle 6 and a spindle nut 7 which meshes with the latter. The spindle/spindle nut gear mechanism 5 is assigned to a drive train 8 which extends from a spindle-proximal drive connection 9a to a spindle nut-proximal drive connection 9b.

The spindle 6 is guided so as to be movable axially in a spindle guide tube 10, wherein the spindle guide tube 10 is co-rotationally connected to the spindle nut 7 and is coupled to the spindle nut-proximal drive connection 9b in an axially fixed manner, presently also in a co-rotational manner.

It is now essential that the spindle nut 7 over its entire length is inserted axially into a portion of the spindle guide tube 10 that is shaped in such a manner that said portion engages with the spindle nut 7 in a form-fitting manner in both directions along the geometric spindle axis A and in the circumferential direction about the geometric spindle axis A.

In the course of assembly, the spindle nut 7 is consequently inserted axially into a portion of the spindle guide tube 10. The “length” of the spindle nut 7 presently means the extent in the axial direction, thus along the geometric spindle axis A. The portion of the spindle guide tube 10 is shaped in such a way that the shape of the tube per se, or the shape of the encircling tube wall, respectively, is relevant in terms of the form-fit with the spindle nut 7. In this way, no additional material or component is required in order to generate the form-fit between the spindle guide tube 10 and the spindle nut 7.

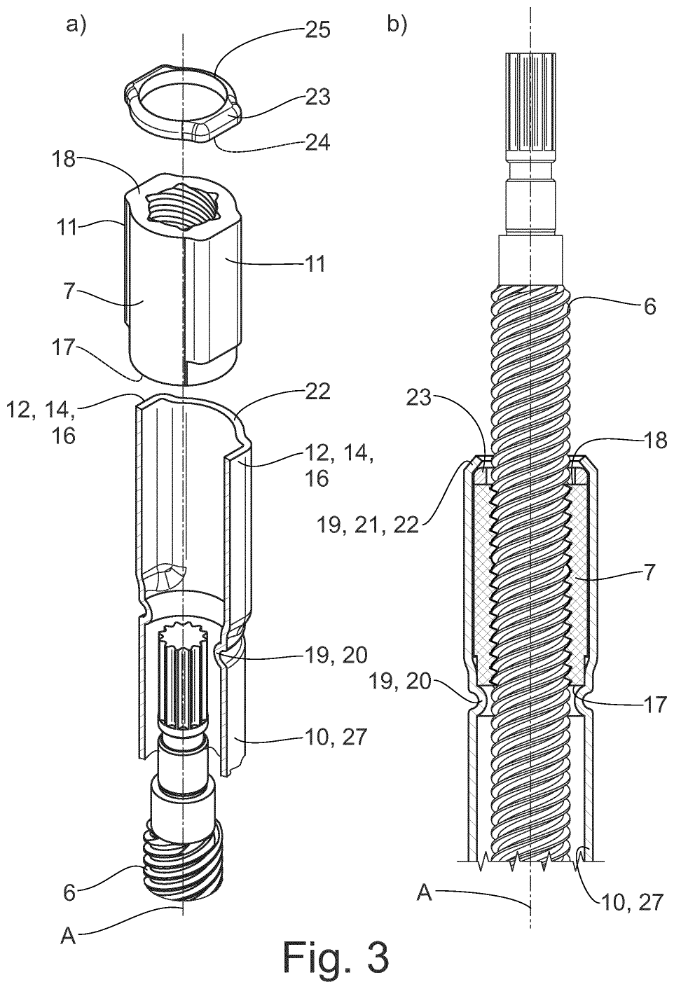

In the embodiment shown in FIG. 2 and FIG. 3, the spindle nut 7 has at least one radially outward-projecting wing 11 which engages in each case with a corresponding internal depression 12 in the spindle guide tube 10 in a form-fitting manner in the circumferential direction about the geometric spindle axis A. In various embodiments, the spindle nut 7 has at least two, presently exactly two, radially outward-projecting wings 11 which engage in each case with a corresponding internal depression 12 in the spindle guide tube 10 in a form-fitting manner in the circumferential direction about the geometric spindle axis A. The term “radially outward-projecting” is presently understood to mean that the wing 11 projects in relation to the otherwise cylindrical external contour.

In various embodiments it can be that the wing 11 is configured from metal and/or the same material as the spindle nut 7 which can be composed of metal. Alternatively however, it is also conceivable that the wing 11 is overmolded on the spindle nut 7 by the injection-molding method.

As shown in the cross section A-A in FIG. 2, the spindle guide tube 10, and by way of the latter the spindle nut 7, can be guided in an axially movable and co-rotational manner in a torsion tube 13, and the torsion tube 13 is coupled to the spindle-proximal drive connection 9a in an axially fixed and co-rotational manner. In various embodiments, the spindle guide tube 10 has at least one radially outward-projecting convexity 14 which engages in each case with a corresponding internal guide groove 15 in the torsion tube 13 in a form-fitting manner in the circumferential direction about the geometric spindle axis A. In various embodiments, the spindle guide tube 2 has at least two, presently exactly two, radially outward-projecting convexities 14 which engage in each case with a corresponding internal guide groove 15 in the torsion tube 13 in a form-fitting manner in the circumferential direction about the geometric spindle axis A. The engagement of the convexity 14 in the guide groove 15 enables a structurally simple and cost-effective solution for supporting the torque of the spindle nut 7. At the same time, reliable guiding of the spindle guide tube 10 in the axial direction in the torsion tube 13 is achieved by this simple construction.

In various embodiments, it is furthermore the case that one outward-projecting convexity 14 is provided for each internal depression 12. As is shown in FIG. 3a), one internal depression 12 and one outward-projecting convexity 14 are in each case congruent in radial terms. The production of the internal depression 12 and/or the outward-projecting convexity 14 can take place in a particularly simple manner if the respective internal depression 12 and/or outward-projecting convexity 14 are/is formed by a corrugation 16, in particular one and the same corrugation 16. As is shown in FIG. 2 and FIG. 3, the corrugation 16 can run parallel to the geometric spindle axis A. The cylindrical tube which has the corrugation 16 has only to be partially widened in order for the corrugation 16 to be generated. In this way, a depression 12 is created internally, and a corresponding congruent convexity 14 is created externally. To this extent, one internal depression 12 and one external convexity 14 are simultaneously generated by each corrugation 16. When viewed from the inside, the external convexity 14 is consequently an internal depression 12 and vice versa.

The spindle nut 7 can in particular be free from externally encircling depressions and/or have a cylindrical surface contour in the circumferential portion or the circumferential portions which is/are free from outward-projecting wings 11. In this way, a spindle nut 7 which is particularly easy to produce can be implemented.

As has already been described above, the spindle nut 7 is disposed so as to be axially fixed in the spindle guide tube 10. For this purpose, the spindle nut 7 at its axial ends 17, 18 can engage in each case in at least one internal protrusion 19, in particular an internally encircling protrusion 19, in the spindle guide tube 10 in a respective form-fitting manner in one of the two directions along the geometric spindle axis A. The term “encircling” is presently understood to mean that the internal protrusion 19 is configured in an encircling manner in the circumferential direction about the geometric spindle axis A. As can be derived in particular from FIG. 3a) and FIG. 3b), the spindle nut 7 is fixed axially in the spindle guide tube 10 between the—in FIG. 3 upper-internal protrusion 19 and the—in FIG. 3 lower-internal protrusion 19.

It can be provided that the internal protrusion 19, with which the spindle nut 7 at its axial end 17 facing the spindle nut-proximal drive connection 9b engages in a form-fitting manner in a first direction along the geometric spindle axis A, is formed by reshaping. The internal protrusion 19, with which the spindle nut 7 at the axial end 17 engages in a form-fitting manner, in the design embodiment that is illustrated in FIG. 2 and FIG. 3 and in some embodiments, is formed as a knurling 20, as a result of which this internal protrusion 19 is particularly easy to produce. In principle however, crimping may also be provided. The aforementioned protrusion 19 secures the spindle nut 7 in the axial direction, in the downward direction in FIG. 2 and FIG. 3.

“Reshaping” herein is understood to mean a material deformation generated by forming. This is a shape-imparting method in which the blank, presently the spindle guide tube blank, made of malleable materials (metal or thermoplastics) is brought into a different shape in a targeted manner, without subtracting material from the blank or adding material to the latter.

The production of the spindle guide tube 10 can be further simplified if the internal protrusion 19, with which the spindle nut 7 at its axial end 18 facing the spindle-proximal drive connection 9a engages in a form-fitting manner in a second direction along the geometric spindle axis A, is likewise formed by reshaping, presently and in some embodiments beading 21, the axial end 22 of the spindle guide tube 10 facing the spindle-proximal drive connection 9a. Beading is a cost-effective and simple method for forming protrusions 19 in a tube. To this extent, the beading procedure permits that the spindle nut 7, which has previously been inserted into the spindle guide tube 10, is established in an axially fixed manner in the spindle guide tube 10 by the beading 21. The clamping force by way of which the spindle nut 7 is jammed in the spindle guide tube 10 can be adjusted by way of the degree of forming the beading 21. In this way, beading achieves axial fixing of the spindle nut 7 in a cost-effective manner, and at the same time makes it possible to adjust the clamping force acting on the spindle nut 7 in a simple manner.

In various embodiments, disposed axially between the spindle nut 7 and the internal protrusion 19, in particular the internal protrusion 19 formed by the beading 21 of the axial end 22 of the spindle guide tube 10, is an annular intermediate piece 23 which transmits an axial clamping force from the spindle guide tube 10, in particular the internal protrusion 19, to the spindle nut 7. In various embodiments, the intermediate piece 23 is a metal disk. The intermediate piece 23 on its end side 24 facing the spindle nut 7 advantageously has an in particular flat geometry which is adapted to the spindle nut 7. The intermediate piece 23, on the end side 25 facing away from the spindle nut 7, has in the radial direction, as shown in FIG. 3a), a curvature or bevel encircling the geometric spindle axis A in the circumferential direction. The curvature or bevel can enable a particularly good contact between the beading 21 and the intermediate piece 23, as a result of which a uniform transmission of force between the beading 21 and the intermediate piece 23 is achieved. The intermediate piece 23 also offers the advantage that the reshaped portion of the spindle guide tube 10 is not impressed into the spindle nut 7 if the spindle nut 7 is made of a plastics material. If no intermediate piece 23 is provided, the spindle nut 7 at its axial end 18 facing the spindle-proximal drive connection 9a can alternatively have such a bevel or curvature.

With a view to stability and an ideally long service life it has proven advantageous for the spindle 6 to be made of metal. Alternatively or additionally, it is possible that the spindle nut 7 and/or the spindle guide tube 10 are/is made of a plastics material, in particular of a thermoplastic material, and/or of metal. The material metal can be used, in some embodiments, for the spindle nut 7 in order to provide a particularly high strength. As a result of a corresponding choice of material, particularly positive frictional properties between the spindle 6 and the spindle nut 7 can be achieved and adapted to the respective specific application of the spindle drive 1. If the spindle guide tube 10 is formed from a plastics material, this plastics material can have a particular resistance in relation to external influences, such as a good resistance in relation to oil, for example.

As is shown in FIG. 2, a drive unit 24 having an electric motor 25 which drives the spindle 6 in a rotating manner can be provided. In this instance, the spindle drive 1 can be used as the active side. A motorized drive of the spindle drive 1 is appreciated as a convenience function, this enabling motorized opening and/or closing of the closure element 3. Alternatively, it is also possible for the spindle drive 1 to be without a motor. In this instance, the spindle drive 1 can be used as the passive side. In this way, the spindle drive 1 is suitable for many applications.

As is shown in FIG. 2, the spindle 6 can be coupled to the drive motor 25 by way of an intermediate gearbox 26. In this instance, the spindle/spindle nut gear mechanism 5 is disposed mechanically downstream of the drive unit 24 in the drive train 8.

In various embodiments, the spindle drive 1 is designed to be restorable. The term “restorable” herein is understood to mean manually restorable. In this instance, it is possible to manually adjust the spindle drive 1, for example to open and/or close the latter, by external forces directed into the closure element 3. Alternatively, it is also possible that the spindle drive 1 is designed to be self-locking. In this instance, it is not possible for the spindle drive 1 to be manually adjusted by external forces directed into the closure element. This can be advantageous as a safeguard against manual adjustment of the closure element 3.

According to a further teaching which is of independent relevance, a closure element assembly 2 of a motor vehicle 4, having a closure element 3 and a spindle drive 1 according to the proposal, is provided. In this context, reference may be made to all statements pertaining to the spindle drive 1 according to the proposal.

Provided according to a further teaching, which is of independent relevance, is a method for producing a spindle drive 1 for a closure element 3 of a motor vehicle 4, in particular a spindle drive 1 according to the proposal, wherein the spindle drive 1 in the assembled state has a spindle/spindle nut gear mechanism 5 which has a spindle 6 and a mating meshing spindle nut 7 for generating linear drive movements along a geometric spindle axis A between a spindle-proximal drive connection 9a and a spindle nut-proximal drive connection 9b for the output of the drive movements, wherein the spindle 6 in the assembled state is guided so as to be movable axially in a spindle guide tube 10 which is connected to the spindle nut 7 in an axially fixed and co-rotational manner, and is coupled to the spindle nut-proximal drive connection 9b in an axially fixed manner. In this context, reference may be made to all statements pertaining to the spindle drive 1 according to the proposal.

In detail, it is provided that a spindle guide tube blank 27 is provided, that the spindle guide tube 10 is formed by incorporating at least one internal depression 12 and at least one internal protrusion 19 into the spindle guide tube blank 27, that subsequently a spindle nut 7 having at least one radially outward-projecting wing 11 is inserted axially into the spindle guide tube 10 in such a way that one radially outward-projecting wing 11 of the spindle nut 7 comes to engage in each case with one assigned inward-directed depression 12 of the spindle guide tube 10 in a form-fitting manner in the circumferential direction about the geometric spindle axis A, and that subsequently the spindle guide tube 10 is formed by a reshaping, in particular beading 21, and the spindle nut 7 is secured axially between the protrusion 19 and the reshaping on the spindle guide tube 10.

As is shown in FIG. 3a), the method makes it possible for the spindle nut 7 to be placed into the spindle guide tube 10 in a simple manner, and for the axial end 22 of the spindle guide tube 10 facing the spindle-proximal drive connection 9a to be subsequently reshaped so as to implement axial fixing of the spindle nut 7 in the spindle guide tube 10. In various embodiments, reshaping is formed by beading 21, but may also be formed by crimping or knurling.

The method permits a modular construction of the spindle drive 1. In this way, spindles 6 having different spindle pitches and complementary spindle nuts 7 can be placed in a respectively identical spindle tube so as to configure different spindle drives 1. Spindles 6 and spindle nuts 7 from different materials can also be used. As a result of reshaping, the clamping force acting on the spindle nut 7 can at the same time be adjusted in a simple manner. As a result of the possibility to combine different spindles 6 and spindle nuts 7 with differently reshaped configurations in a simple manner, a simple variant management in terms of the spindle drive 1 can be implemented.

1. A spindle drive for a closure element of a motor vehicle, comprising a spindle/spindle nut gear mechanism which has a spindle and a mating meshing spindle nut for generating linear drive movements along a geometric spindle axis between a spindle-proximal drive connection and a spindle nut-proximal drive connection for the output of the drive movements, wherein the spindle is guided so as to be movable axially in a spindle guide tube which is connected to the spindle nut in an axially fixed manner and co-rotational manner, and is coupled to the spindle nut-proximal drive connection in an axially fixed manner,
wherein the spindle nut over its entire length is inserted axially into a portion of the spindle guide tube that is shaped in such a manner that said portion engages with the spindle nut in a form-fitting manner in both directions along the geometric spindle axis and in the circumferential direction about the geometric spindle axis.

2. The spindle drive as claimed in claim 1, wherein the spindle nut has at least one radially outward-projecting wing which engages in each case in a corresponding internal depression in the spindle guide tube in a form-fitting manner in the circumferential direction about the geometric spindle axis.

3. The spindle drive as claimed in claim 2, wherein the spindle guide tube, and by way of the latter the spindle nut, is guided in an axially movable and co-rotational manner in a torsion tube, and in that the torsion tube is coupled to the spindle-proximal drive connection in an axially fixed and co-rotational manner.

4. The spindle drive as claimed in claim 3, wherein provided for each internal depression is one outward-projecting convexity.

5. The spindle drive as claimed in claim 4, wherein the respective internal depression and/or outward-projecting convexity is formed by a corrugation.

6. The spindle drive as claimed in claim 1, wherein the spindle nut is free from externally encircling depressions, and/or has a cylindrical surface contour in the circumferential portion or circumferential portions that is/are free from outward-projecting wings.

7. The spindle drive as claimed in claim 1, wherein the spindle nut at its axial ends engages in each case in at least one internal protrusion, in the spindle guide tube in a respective form-fitting manner in one of the two directions along the geometric spindle axis.

8. The spindle drive as claimed in claim 7, wherein the internal protrusion, by way of which the spindle nut at its axial end facing the spindle nut-proximal drive connection engages in a form-fitting manner in a first direction along the geometric spindle axis, is formed by reshaping the spindle guide tube, in particular knurling or crimping.

9. The spindle drive as claimed in claim 7, wherein the internal protrusion, by way of which the spindle nut at its axial end facing the spindle-proximal drive connection engages in a form-fitting manner in a second direction along the geometric spindle axis, is formed by reshaping, the axial end of the spindle guide tube facing the spindle-proximal drive connection.

10. The spindle drive as claimed in claim 7, wherein disposed axially between the spindle nut and the internal protrusion, the axial end of the spindle guide tube, is an annular intermediate piece which transmits an axial clamping force from the spindle guide tube to the spindle nut.

11. The spindle drive as claimed in claim 1, wherein the spindle is made of metal, and/or in that the spindle nut and/or the spindle guide tube are/is made of a plastics material, and/or of metal.

12. The spindle drive as claimed in claim 1, wherein provided is a drive unit having an electric motor which drives the spindle in a rotating manner, or wherein the spindle drive is without a motor.

13. The spindle drive as claimed in claim 1, wherein the spindle drive is designed to be restorable or self-locking.

14. A closure element assembly of a motor vehicle, having a closure element and a spindle drive as claimed in claim 1.

15. A method for producing a spindle drive for a closure element of a motor vehicle, wherein the spindle drive in the assembled state has a spindle/spindle nut gear mechanism which has a spindle and a mating meshing spindle nut for generating linear drive movements along a geometric spindle axis between a spindle-proximal drive connection and a spindle nut-proximal drive connection for the output of the drive movements, wherein the spindle in the assembled state is guided so as to be movable axially in a spindle guide tube which is connected to the spindle nut in an axially fixed and co-rotational manner, and is coupled to the spindle nut-proximal drive connection in an axially fixed manner,
wherein a spindle guide tube blank is provided,
the spindle guide tube is formed by incorporating at least one internal depression and at least one internal protrusion into the spindle guide tube blank,
subsequently a spindle nut having at least one radially outward-projecting wing is inserted axially into the spindle guide tube in such a way that one radially outward-projecting wing of the spindle nut comes to engage in each case with one assigned inward-directed depression of the spindle guide tube in a form-fitting manner in the circumferential direction about the geometric spindle axis, and
subsequently the spindle guide tube is formed by reshaping, and the spindle nut is secured axially between the protrusion and the reshaping on the spindle guide tube.

16. The spindle drive as claimed in claim 1, wherein the spindle nut has at least two radially outward-projecting wings which engage in each case in a corresponding internal depression in the spindle guide tube in a form-fitting manner in the circumferential direction about the geometric spindle axis.

17. The spindle drive as claimed in claim 3, wherein the spindle guide tube has at least one radially outward-projecting convexity which engages in each case in a corresponding internal guide groove in the torsion tube in a form-fitting manner in the circumferential direction about the geometric spindle axis.

18. The spindle drive as claimed in claim 4, wherein one internal depression and one outward-projecting convexity are in each case congruent in radial terms.

19. The spindle drive as claimed in claim 5, wherein the corrugation runs parallel to the geometric spindle axis.

20. The spindle drive as claimed in claim 10, wherein the intermediate piece is a metal disk.
